(19) United States
(12) Patent Application Publication
(10) Pub. No.: US 2024/0401645 A1
(43) Pub. Date: Dec. 5, 2024

(54) HIGH FLEXIBILITY SEALING DEVICE, IN PARTICULAR FOR HOUSEHOLD APPLIANCES

(71) Applicant: AKTIEBOLAGET SKF, GOTEBORG (SE)

(72) Inventors: Gianni Alvise COGNOLATO, Trofarello (IT); Giorgia D'AMICO, Torino (IT)

(21) Appl. No.: 18/670,816

(22) Filed: May 22, 2024

(30) Foreign Application Priority Data
May 29, 2023 (IT) 102023000010770

(51) Int. Cl. F16C 33/76; D06F 37/26; F16C 33/78

(52) U.S. Cl. CPC F16C 33/768; D06F 37/263; F16C 33/7823

(57) ABSTRACT

A sealing device is provided for exerting a static hydraulic sealing action between two mechanical elements arranged facing each other and between which there is a variable axial distance. The sealing device includes an annular elastomeric element having a first sealing lip extending cantilevered radially outward from a support element and formed by adjacent annular portions. The first sealing lip has first and second branches arranged at an angle relative to each other so as to form in radial cross section a V-shape oriented radially and converging in a direction away from an axis of symmetry of the elastomeric annular element. The first branch is provided with a cantilevered annular spur forming a fulcrum designed to open or close the V-shape depending on the variable axial distance.

### CROSS-REFERENCE

This application claims priority to Italian patent application no. 102023000010770 filed on May 29, 2023, the contents of which are fully incorporated herein by reference.

### BACKGROUND OF THE INVENTION

The present invention relates to sealing devices, and more particularly to hydraulic sealing devices for protecting bearings used in appliances such as washing machines.

In a washing machine, the rotating basket, which is intended to contain the laundry to be washed and which rotates partially immersed in the washing fluid contained in the washing tub, is generally axially supported by a rolling bearing (or by a group of rolling bearings) inserted inside in an annular seat of a housing or support arranged behind the basket.

In order to protect the rolling bearing an annular washer-shaped plate is provided, arranged facing the seat of the housing inside which the rolling bearing is inserted, and supported fixed, i.e. in a static configuration, radially on the outside of cup-shaped bell member which during use rotates together with the basket.

A sealing device is mounted between a front face of the housing and the annular plate, statically inserted inside the housing, in front of the seat for the rolling bearing, and cooperates by means of one or more sliding contact lips with a cylindrical side wall of the bell member, exerting a dynamic hydraulic sealing action thereon.

However, it has been established that, in particular during the discharging of the washing fluid, part of the washing fluid may seep beyond the annular plate and the sealing device, in direction toward the rolling bearing, which may thereby reduce the working life of the bearing.

In order to overcome this drawback, the sealing device may be provided with one or more static sealing lips which cooperate with the annular plate. However, such static sealing lips do not appear to provide a feasible solution since the distance, or play, between the front face of the housing and the annular plate is not stable during use, but may vary within a fairly wide range, due both to assembly tolerances and to any differential thermal expansion occurring between the various components. The effect of differential thermal expansion is increased by the greater rotational speeds (e.g., 1,300 rpm) of baskets in modern washing machines, which typically generate increased temperatures.

### SUMMARY OF THE INVENTION

The object of the present invention is to provide a sealing device for protecting a rolling bearing, in particular for household appliances such as washing machines, which does not have the drawbacks of the prior art and in particular is capable of ensuring an optimum and reliable static hydraulic seal between an annular protection plate, which during use is fixed, and a housing for the rolling bearing.

According to the present invention, a sealing device for protecting a rolling bearing, in particular for household appliances such as washing machines, is provided, as defined in the attached claims.

The present invention therefore also includes a washing machine equipped with such a sealing device.

### BRIEF DESCRIPTION OF THE SEVERAL VIEWS OF THE DRAWINGS

Further characteristic features and advantages of the present invention will become clear from the following description of some non-limiting embodiments thereof, provided with reference to the attached drawings, in which:

FIG. 1 shows schematically in radial cross-section a partial view of a sealing device according to the invention, arranged in a working position between component parts of a washing machine, otherwise known and not illustrated in detail for the sake of simplicity;

FIG. 2 shows only schematically and in radial cross-section, on a larger scale, the same partial view of the sealing device according to FIG. 1, of which only the radial section thereof situated on one side of its axis of symmetry A is shown, the missing-diametrically opposite-radial section part being symmetrical;

FIG. 3 shows, only schematically and on a further enlarged scale, a detail of a radially outer portion of the radially sectioned view of the sealing device according to FIG. 2;

FIG. 4 shows, on a smaller scale and in radial cross-section, a non-limiting example of assembly of the sealing device according to the invention in a washing machine; and

FIG. 5 shows, only schematically and on a further enlarged scale, a detail of a static sealing lip belonging to the same radially outer portion of the radially sectioned view of FIG. 2, but of the sealing device realized according to a possible variation of the invention.

### DETAILED DESCRIPTION OF THE INVENTION

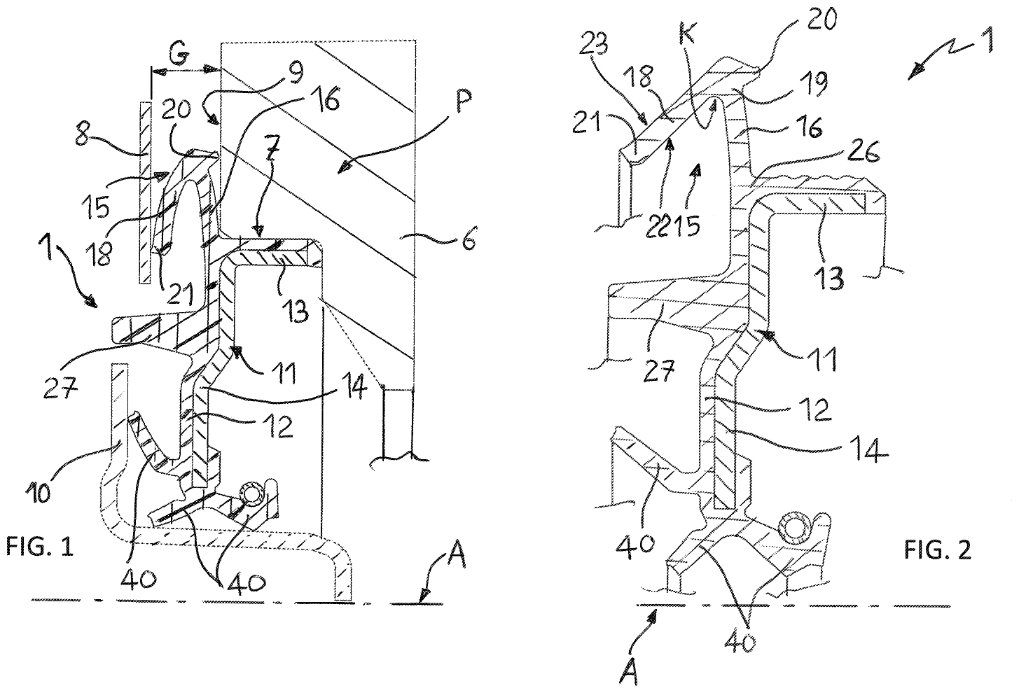

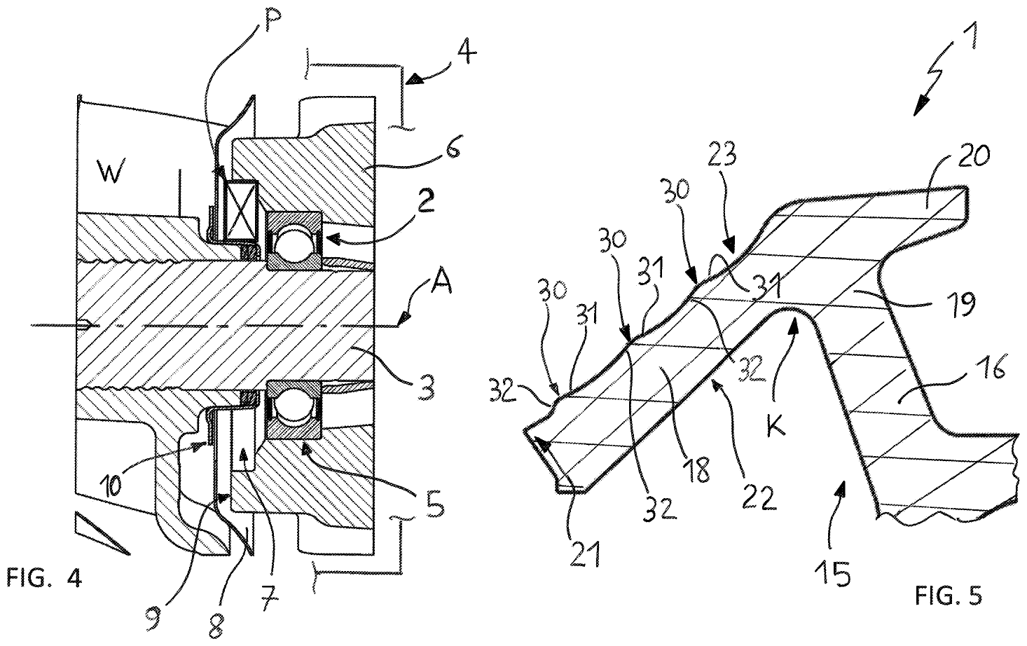

With reference to FIGS. 1 and 4, the reference number 1 denotes a sealing device intended to protect a rolling bearing 2 of a household appliance during use, in particular a rolling bearing 2 for supporting an axle or shaft 3 of a laundry wash basket (the basket being known and not shown for simpler illustration) of a washing machine 4, otherwise known and shown only partly and only schematically for simplified illustration in FIG. 4.

The sealing device 1 is mounted, during use, in a position P represented schematically in FIG. 4 by a block, and the axle or shaft 3 rotates about an axis A which, as will be seen, is also the axis of symmetry of the sealing device 1 and of the rolling bearing 2.

The sealing device 1 is at least partially arranged inserted statically, preferably substantially with an interference fit, inside of a first annular seat 7 of a support or housing 6 of the washing machine 4 for the rolling bearing 2.

A second annular seat 5 for receiving the rolling bearing 2, inserted and fitted, is formed inside the housing 6. The seat 5 is arranged axially further away or distal with respect to the seat 7, on one side of the household appliance indicated by W in FIG. 4, inside of which, in the case of a washing machine 4, a washing fluid may be present. In this way, the rolling bearing 2 may be protected by the sealing device 1 from any infiltration of washing fluid, as discussed below.

The sealing device 1 is configured to exert, during use, a static hydraulic sealing action between two mechanical elements which are arranged facing each other and between which there is an axial distance or play G (FIG. 1), which is potentially variable within a given range, due to assembly tolerances and/or any differential thermal expansion.

In the non-limiting example shown, the two mechanical elements that are arranged facing each other consist of a static annular plate or disc 8 for protecting the rolling bearing 2, which separates the bearing 2 from the side W (FIG. 4), and a front face 9 of the housing 6, which is directed toward or faces the plate 8.

A known cup-shaped bell member 10 is also mounted on the axle or shaft 3, the bell member 10 rotating integrally with the axle or shaft 3 during use, as well as with the laundry wash basket of the washing machine 4, which is known and not shown for the sake of simplicity.

The sealing device 1 (FIGS. 1, 2 and 3) includes an annular support element 11, which is preferably metallic and is substantially rigid, and an elastomeric annular element 12 formed integrally or as one piece with the annular support element 11 in a known manner, such as for example by means of gluing during vulcanization.

The annular support element 11 includes a radially outer sleeve portion 13, configured to fit the same statically inside the seat 7 in a generally known manner, and a flange portion 14, which extends radially inward from the sleeve portion 13 and substantially perpendicular to a common axis of symmetry A of the annular support element 11 of the elastomeric annular sealing element 12, as well of the entire scaling device 1.

The annular sealing element 12, which is made of elastomeric material, includes at least one first, elastically deformable, annular sealing lip 15 which extends cantilevered from the support element 11.

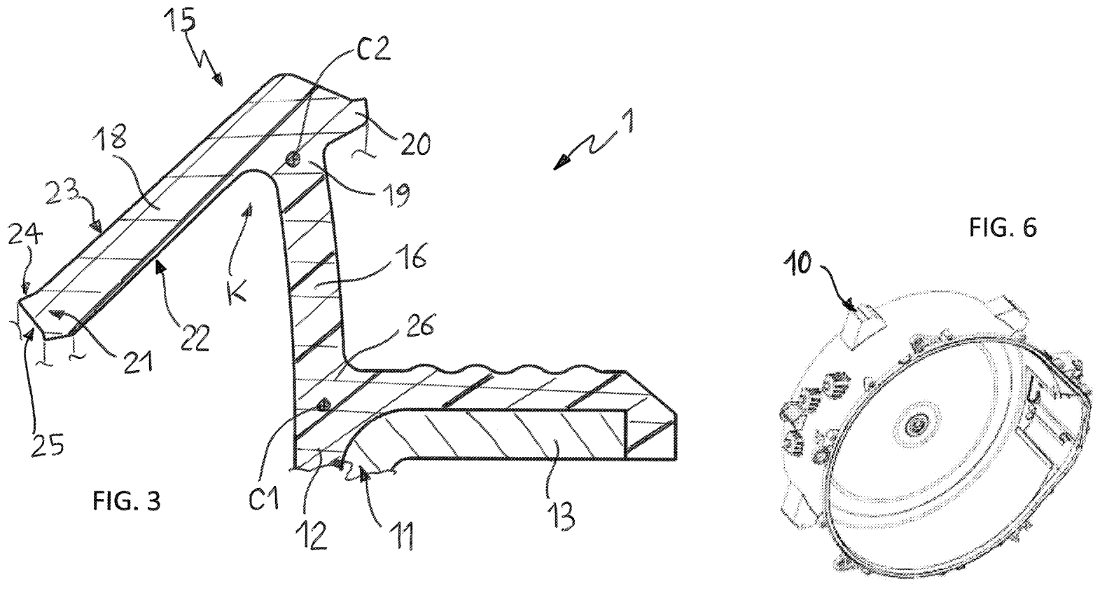

According to one aspect of the invention, the first annular sealing lip 15 includes, in radial cross-section, a first branch 16 and a second branch 18 which are arranged in sequence starting from the support element 11 and are configured so as to be arranged at an angle relative to each other so as to form in radial cross-section (FIGS. 2 and 3) a “V” or V-shape arranged oriented radially and also obliquely with respect to the axis of symmetry A. Further, the V/V-shape formed by the first and second branches 16, 18 is directed on the opposite side to the axis of symmetry A of the elastomeric annular element 12, i.e. so that a vertex K of the V is directed radially outward and the two branches 16, 18 converge in a direction radially away from the axis of symmetry A.

The first branch 16 and the second branch 18 consist of respective adjacent annular portions, each having a generally frustoconical shape, of the annular sealing element 15. Specifically, the first branch 16 projects totally or entirely cantilevered from the radially outer sleeve portion 13 of the support element 11, in a substantially radial direction and radially on the outside thereof. The second branch 18 projects entirely cantilevered from a free end 19 of the first branch 16, both in an axial direction away from the support element 11 and in a radial direction toward the axis of symmetry A. As such, the entire sealing lip 15 is completely free from the support element 11, with respect to which it projects in a totally cantilevered manner, without being prevented from performing any movements by the support element 11 (i.e., the lip 15 is not restrained by the element 11).

According to an important aspect of the invention, the first annular sealing lip 15 is also configured so that, in a radial section and at the vertex K of the V formed by the angled junction of the second branch 18 with the first branch 16, an annular spur 20 is cantilevered from the first branch 16 so as to extends in a substantially axial direction from the free end 19 of the first branch 16 and on a side of the branch 16 opposite to the second branch 18; that is, the spur 20 and the second branch 18 extend from opposing sides of the first branch 16.

During use, the annular spur 20 is configured to form a fulcrum arranged between the first and second branches 16, 18 and is designed to cooperate with a first element of the two facing mechanical elements, which in the depicted example is formed by the front face 9 of the housing 6, so as to push a free end 21 of the second branch 18, opposite to the first branch 16, so as to cooperate with a second element of the two facing mechanical elements, in the example shown formed by the plate 8, and so as to push also the entire second branch 18 against the surface of the plate 8 in order to close the seal lip 15 in the direction of the axis A and to ensure correct positioning thereof, i.e. avoid overturning thereof toward the direction of the axis A.

For this purpose also, the annular spur 20 is formed so that a radial thickness thereof is preferably less than a thickness, measured radially (i.e., a radial thickness) of both the first and the second branches 16, 18 of the annular sealing lip 15.

From the description provided above, it is clear that the annular portion of the scaling lip 15 forming the second branch 18 is bounded radially on the inside by a conical surface 22 and on the outside by a conical surface 23, the two conical surfaces 22, 23 being substantially parallel to each other and have a taper directed on the opposite side to the annular support element 11.

As used herein, the term “taper” is understood as meaning the direction or sense in which the ideal vertex of the conical side surfaces 22 and 23 is situated or located; in the depicted example, such a vertex intersects the axis of symmetry A on the opposite side to the support element 11 so that the taper of the conical side surfaces 22, 23 is directed toward the left in FIGS. 1 and 2.

According to a further, non-secondary or important aspect of the present invention, the second branch 18 of the sealing lip 15 has a free end 21 arranged on the opposite side to the first branch 16 and formed as an annular projection bounded by two opposite annular surfaces 24, 25, as indicated in FIG. 3, which are inclined with respect to the axis of symmetry A so as to form an acute angle between the two surfaces 24, 25. In particular, the annular surfaces 24 and 25 are inclined and project outwardly with respect to the outer conical surface 23, and are also inclined with respect to a line perpendicular to the surface 23, so as to ensure a contact point also in the minimum play condition G.

The annular projection forming the free end 21 of the cantilevered branch 18 of the sealing lip 15 projects axially cantilevered from an extrados face (i.e., the upper, outer face) of the annular portion of the sealing lip 15 forming the second branch 18. The extrados/outer face is formed or bounded, in the case in question, by the conical side surface 23 and is therefore directed on the opposite side of the first branch 16, more specifically, opposite to the annular portion of the scaling lip 15 forming the first branch 16.

The annular portion of the lip 15 forming the first branch 16 preferably has a length, measured in a radial direction (i.e., a radial length), less than a radial length of the annular portion of the lip 15 forming the second branch 18, the radial length of the second branch 18 being measured along a generatrix (i.e., generated by) of the respective conical surfaces 23, 22 delimiting the respective extrados/outer and intrados/inner faces of the annular portion of the lip 15 forming the second branch 18.

Furthermore, the annular portion of the lip 15 forming the first branch 16 is configured so as to form at a respective root end 26 of the first branch 16 and at a free end 19 of the first branch 16 (FIG. 3), respectively close to and distal with respect to the support element 11, respective hinge points, indicated as C1 and C2 in FIG. 3, designed to allow rotation of the first branch 16 with respect to the support element 11 and of the second branch 18 with respect to the first branch 16, in directions away from and towards the axis of symmetry A, so as to open and close the V or V-shape formed by the conjunction of the branches 16, 18 depending on the amount of the axial distance or play G present in each case between the two facing mechanical elements, in the example shown consisting of the plate 8 and the housing 6, in particular the front face 9 of the housing 6.

According to a further characteristic feature of the present invention, the elastomeric annular element 12 comprises a second annular projection 27 (FIGS. 1 and 2) which extends axially cantilevered on the opposite side to the support element 11 and away from the support element 11, and within the frustoconical annular portion of the sealing lip 15 forming the second branch 18, as far as a point substantially flush with, or slightly beyond, the free end 21 of the second branch 18 of the scaling lip 15.

As shown in FIG. 5, in which the details similar to or the same as those already described above are indicated by the same reference numbers, in a possible variant of the sealing device 1 described hitherto, the conical extrados or outer face 23 of the frustoconical annular portion of the scaling lip 15 forming the second branch 18 is provided with a plurality of annular reliefs 30 arranged sequentially in the axial direction.

Each annular relief 30 is bounded by opposite annular surfaces 31, 32 inclined with respect to the axis of symmetry A so as to form an obtuse angle between them. The reliefs 30 preferably have a height comparable with, or less than, the height of the annular projection formed by the free end 21 of the second branch 18 that is arranged on the opposite side to the first branch 16.

Due to the reliefs 30, it is possible to ensure that, for any opening angle of the V formed by the conjunction of the two branches 16, 18, a linear sealing action is always exerted by the sealing lip 15 against the plate 8, including also when the play G is minimal.

On the one hand, the presence of the spur 20 prevents the two branches 16, 18 of the scaling lip 15 from being accidentally or unintentionally “overturned”, in which case the vertex K of the V would be directed toward the axis of symmetry A, instead of on the opposite side thereto or being directed away from the axis A, such overturning potentially occurring if there is maximum play G and the presence of pressure, for example due to the washing fluid, on the side W. On the other hand, the spur 20 allows the V formed by the two branches 16, 18 of the scaling lip 15 to open/close depending on the amount of the play G.

The optimum seal between the elements 6 and 8 is obtained also in the case of maximum play G, due both to the presence of the spur 20 and to the projection formed by the free end 21 of the branch 18. As such, all the objects of the present invention are therefore achieved.

Finally, it should be noted that the present invention also includes a household appliance, in particular a washing machine 4, comprising a rotating axle 3 supported by a rolling bearing 2 arranged inside a housing 6 of the household appliance 4, a stationary annular plate or disc 8 for protecting the rolling bearing 2, arranged facing the housing 6, and a sealing device such as the sealing device 1 described herein, inserted integrally inside the housing 6 and configured to provide a static hydraulic seal between the annular plate 8 and the front face 9 of the housing 6 and directed toward the annular plate 8, the annular plate 8 being arranged at a variable axial distance G from the housing 6.

In this configuration of the household appliance, the sealing device 1 as described herein is provided radially on the inside also with a plurality of known lips 40 for ensuring both a radial and an axial hydraulic seal, intended to cooperate dynamically during use with the bell member 10, as shown in FIG. 4.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A sealing device for protecting a rolling bearing of a household appliance, the sealing device exerting a static hydraulic sealing action between two mechanical elements arranged facing each other and spaced apart by a variable axial distance, the sealing device comprising:
a substantially rigid annular support element including a radially outer sleeve portion; and
an annular elastomeric element integrally formed with the annular support element, having an axis of symmetry and including an elastically deformable, first annular sealing lip extending cantilevered from the outer sleeve portion of the support element, the first annular sealing lip having a first branch projecting radially from the sleeve portion of the support element in a direction away from the axis of symmetry and a second branch extending from a free end of the first branch in a direction both axially away from the support element and radially toward the axis of symmetry, the first and second branches being arranged at an angle relative to each other so as to form in radial cross-section a V-shape oriented radially converging in a direction away from the axis of symmetry of the elastomeric annular element and constituting adjacent annular portions of the first sealing lip.

2. The sealing device according to claim 1, wherein the first annular sealing lip includes an annular spur extending axially from the free end of the first branch of the sealing lip, the annular spur being located on a side of the first branch opposite to the second branch and at a vertex of the V-shape formed by the first and second branches, the annular spur being configured to form a fulcrum arranged between the first and second branches and designed to cooperate with the first element of the two facing mechanical elements during use of the sealing device so as to push a free end of the second branch, opposite to the first branch, so that the free end of the second branch engages with the second element of the two facing mechanical elements to push the second branch toward the axis of symmetry.

3. The sealing device according to claim 2, wherein a radial thickness of the annular spur is less than a radial thickness of each one of the first and second branches of the first annular sealing lip.

4. The sealing device according to claim 1, wherein the second branch of the first annular sealing lip bounded radially by an inner conical surface and an outer conical surface, the inner and outer conical surfaces being substantially parallel, and has a taper directed on the opposite side to the annular support element.

5. The sealing device according to claim 1, wherein the second branch of the first annular sealing lip has a free end arranged on a side opposite to the first branch of the sealing lip and formed as an annular projection bounded by two opposite annular surfaces inclined with respect to the axis of symmetry and forming an acute angle, the annular projection extending axially cantilevered from an outer face of the second branch, the outer face of the second branch being located on a side of the second branch opposite to the first branch of the first annular sealing lip.

6. The sealing device according to claim 1, wherein the first branch of the first annular sealing lip has a radial length less than a radial length of the second branch of the first annular sealing lip.

7. The sealing device according to claim 1, wherein a hinge point is formed at a root end of the first branch of the first annular sealing lip adjacent to the support element and configured to enable rotation of the first branch with respect to the support element and another hinge point is formed at the free end of the first branch distal from the support element and configured to enable rotation of the second branch with respect to the first branch such that the V-shape formed by the first and second branches opens or closes depending on the axial distance between the two mechanical elements.

8. The sealing device according to claim 1, wherein the annular elastomeric element includes an annular projection extending axially cantilevered from a side of the elastomeric element opposite to the support element and located radially within the second branch of the first annular sealing lip, the annular projection extending axially away from the support element as far as a point substantially flush with or slightly beyond a free end of the second branch.

9. The sealing device according to claim 1, wherein an outer face of the second branch of the first annular sealing lip is provided with a plurality of annular reliefs arranged sequentially in an axial direction, each annular relief being bounded by opposite annular surfaces inclined with respect to the axis of symmetry so as to form an obtuse angle, each relief having a height equal to or less than a height of an annular projection formed at a free end of the second branch on a side opposite to the first branch of the first annular sealing lip.

10. A household appliance comprising:
a housing having a front face,
a rotating axle supported by a rolling bearing arranged within the housing,
a stationary annular plate for protecting the rolling bearing, arranged facing the front face of the housing and being spaced from the front face by a variable axial distance, and
a sealing device according to claim 1 inserted integrally inside the housing and configured to provide a static hydraulic seal between the annular plate and the front face of the housing, the sealing device being provided with a plurality of lips on a radial inner side of the sealing device for ensuring both a radial dynamic hydraulic seal and an axial dynamic hydraulic seal.
